(19) United States
(12) Patent Application Publication
(10) Pub. No.: US 2007/0123110 A1
(43) Pub. Date: May 31, 2007

(54) Ultrasonic volumetric imaging by coordination of acoustic sampling resolution, volumetric line density, and volume imaging rate

(75) Inventor: Gary A. Schwartz, Seattle, WA (US)

Correspondence Address: PHILIPS MEDICAL SYSTEMS;PHILIPS INTELLECTUAL PROPERTY & STANDARDS, P.O. BOX 3003, 22100 BOTHELL EVERETT HIGHWAY, BOTHELL, WA, 98041-3003, US

(73) Assignee: KONINKLIJKE PHILIPS ELECTRONICS N.V., Eindhoven (NL)

(21) Appl. No.: 10/574,184

(22) PCT Filed: Sep. 21, 2004
(86) PCT No.: PCT/IB04/51817

§ 371 Date: Mar. 30, 2006

Related U.S. Application Data
(60) Provisional application No. 60/509,629, filed on Oct. 8, 2003.

(51) Int. Cl. H01R 33/00

(52) U.S. Cl. 439/638

(57) ABSTRACT

In an ultrasonic diagnostic imaging system which scans a volumetric region, the sampling bandwidth or spatial resolution is matched to the achievable transducer resolution determined by the aperture size and the wavelength and the desired output bandwidth or volume imaging rate. In an illustrated embodiment this is done by controlling the spatial point spread function of the beams used to scan the volumetric region to provide a more optimal relationship between the acoustic sampling resolution, the desired output line density, and the volume imaging rate. The benefits of this optimization can be to maximize the information content and information movement efficiency by not acquiring more resolution than can be utilized, and to provide a more optimal sampling function, using the aperture function to limit the spatial bandwidth.

This invention relates to ultrasonic diagnostic imaging and, more particularly, to controlling the relationship of the acoustic sampling resolution, the desired output line density, and the volume imaging rate in ultrasonic volumetric imaging systems.

Ultrasonic diagnostic imaging systems are now capable of scanning volumetric regions of a body for the production of three dimensional images of the volumetric region. Since many more beams are necessary to scan a volumetric region as compared to the planar region of a two dimensional image, the time required to scan a volumetric region can be much greater, causing the rate at which volumetric images are created to be relatively low. One approach to maintaining an acceptable image rate is to predetermine a constant number of transmit beams which will be used to scan a nominal volumetric region for a given procedure such as cardiac imaging. As the user adjusts the depth of the image field to encompass a greater depth than that of the nominal volume, the frame rate will decrease as greater time is required to receive echoes from the greater depth. If the user adjusts a lateral dimension of the nominal volume so that a wider volumetric region is scanned, the transmit beams are spread out more widely to scan the wider volume and the beam density declines. This decline in beam density can result in a spatial undersampling of the volumetric region as the beam density decreases. For some applications a minimal spatial undersampling of the image volume may be hardly noticeable. However, for other applications deleterious image artifacts will appear. Spatial undersampling of a planar or volumetric region will give rise to a shimmering effect in the image, and it may seem as though the image is being viewed through a grate or screen. In certain diagnostic applications such as a search for lesions of the liver, the pathology is often diagnosed by discerning subtle variations of the texture of the liver in the image. The speckle pattern of the ultrasound image can play a role in this diagnosis as the clinician looks for subtle changes in the speckle pattern of the image of the liver. Such subtle differences can be masked by the scintillating or shimmering artifacts of spatial undersampling. Accordingly it is desirable to prevent or at least control spatial sampling artifacts so that such diagnosis will not be impeded.

In accordance with the principles of the present invention, an ultrasonic volumetric imaging system is described in which spatial sampling is controlled by control of the acoustic imaging point spread function. In an illustrated embodiment the acoustic imaging point spread function is coordinated with the line density of the volumetric region to produce a desired spatial sampling of the volumetric region. Through such control an acceptable level of spatial sampling artifacts may be maintained as the size or shape of the volumetric region is changed. In accordance with another embodiment of the invention, the scanning of greater depths may be afforded by control of the point spread function within acceptable levels of acoustic output.

In the drawings:

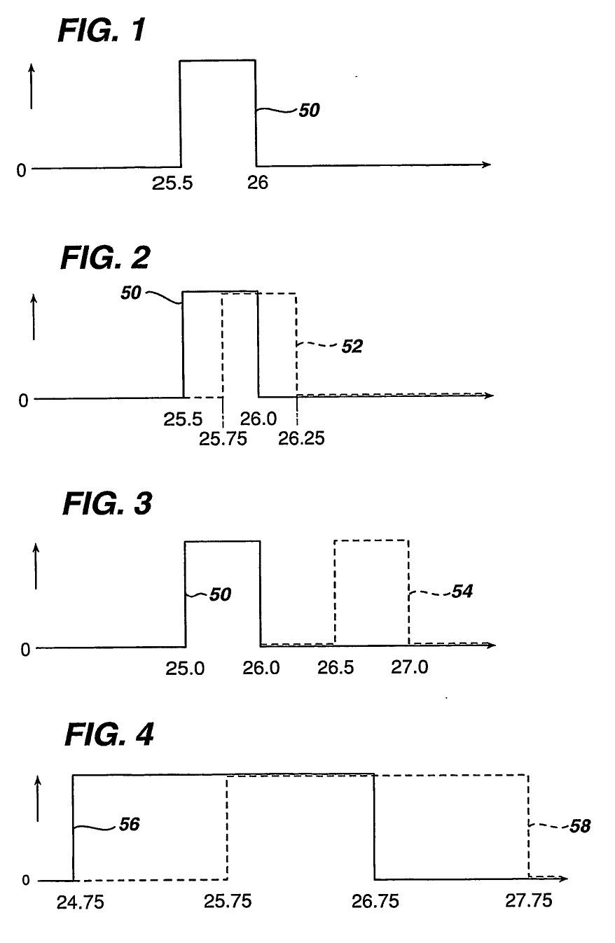

FIG. 1 illustrates an idealized beam intensity in one dimension.

FIG. 2 illustrates the idealized beam intensity of two beams which provides adequate spatial sampling.

FIG. 3 illustrates the idealized beam intensity of two more widely separated beams which provides spatial sampling which fails to satisfy the Nyquist criterion.

FIG. 4 illustrates the idealized beam intensity of two more widely separated beams which provides spatial sampling which satisfies the Nyquist criterion.

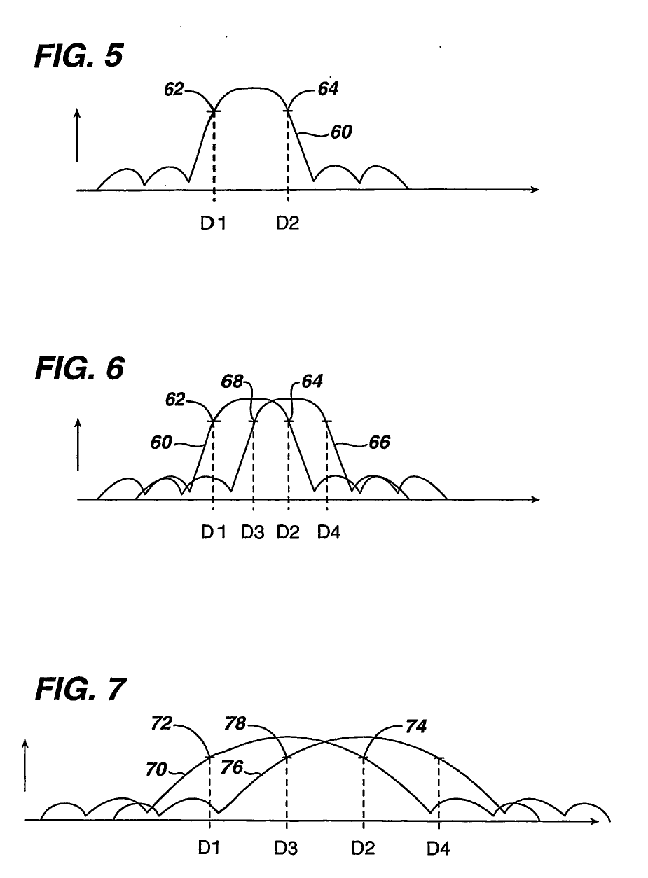

FIG. 5 illustrates the exemplary lobe pattern of an ultrasound beam.

FIG. 6 illustrates the exemplary lobe patterns of two ultrasound beams which provide spatial sampling which satisfies the Nyquist criterion.

FIG. 7 illustrates the exemplary lobe patterns of two more widely separated ultrasound beams which provide spatial sampling which satisfies the Nyquist criterion.

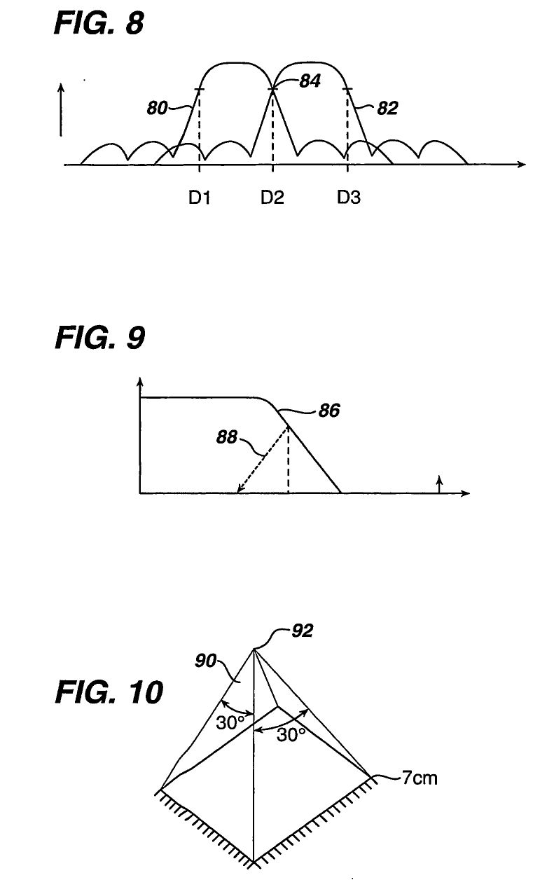

FIG. 8 illustrates the exemplary lobe patterns of two ultrasound beams which provide spatial sampling which fails to satisfies the Nyquist criterion by a controlled degree.

FIG. 9 illustrates an exemplary spatial sampling spectrum.

FIG. 10 illustrates the azimuth and elevation dimensions of a pyramidal volumetric region which is to be efficiently scanned in accordance with the principles of the present invention.

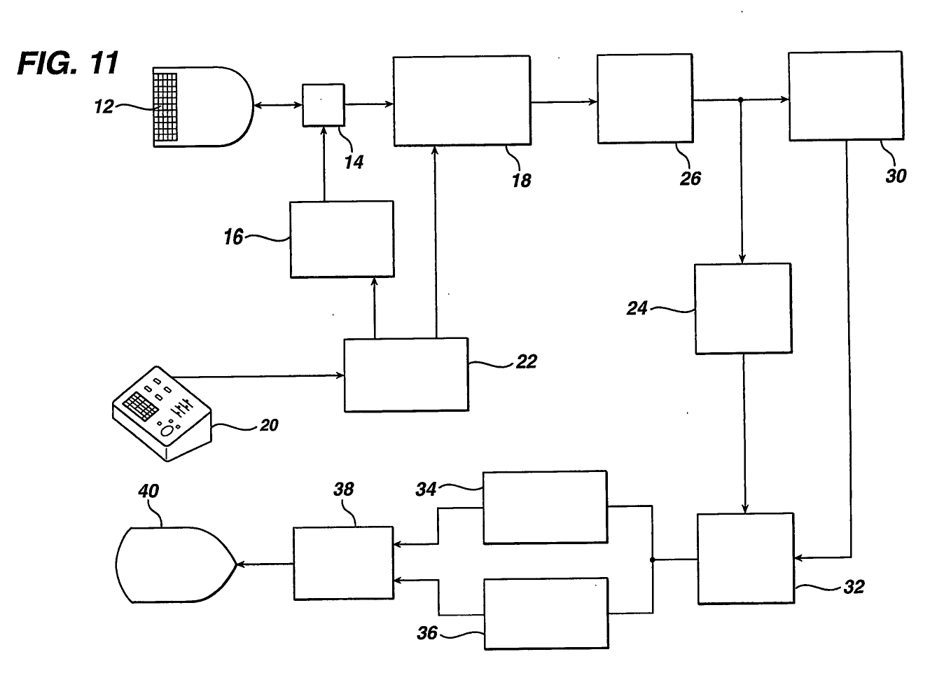

FIG. 11 illustrates a volumetric ultrasonic diagnostic imaging system constructed in accordance with the principles of the present invention.

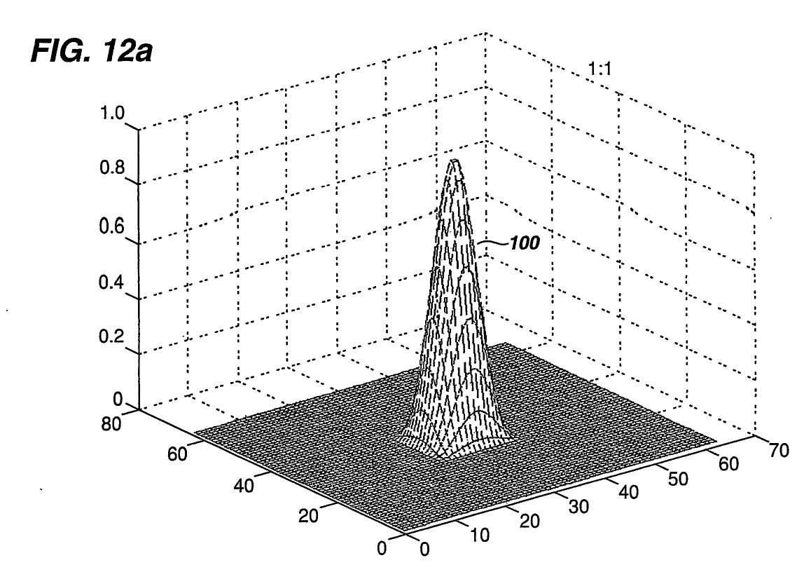

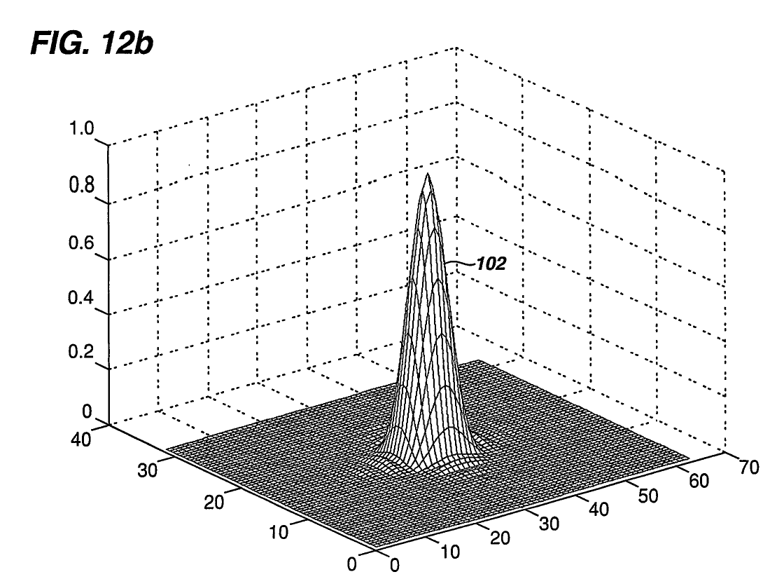

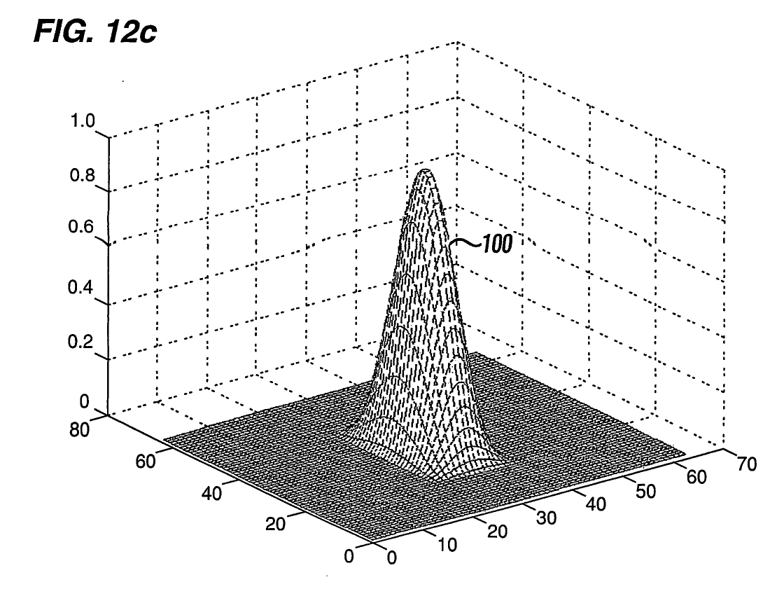

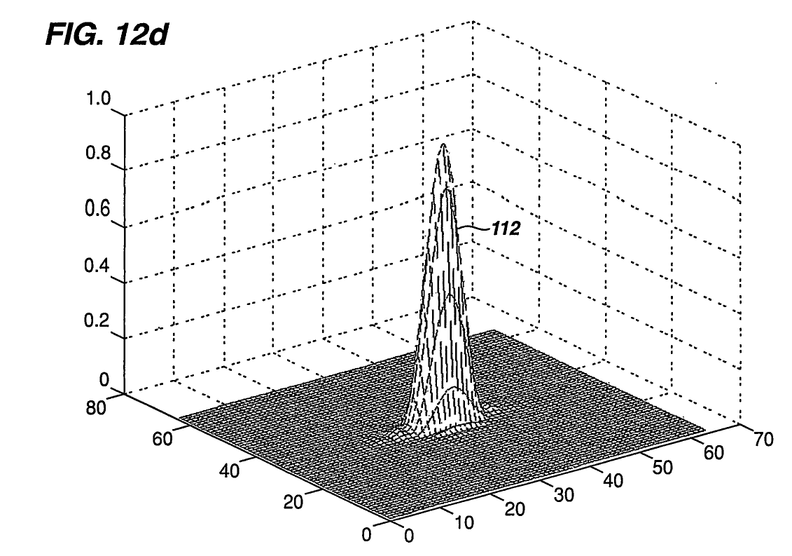

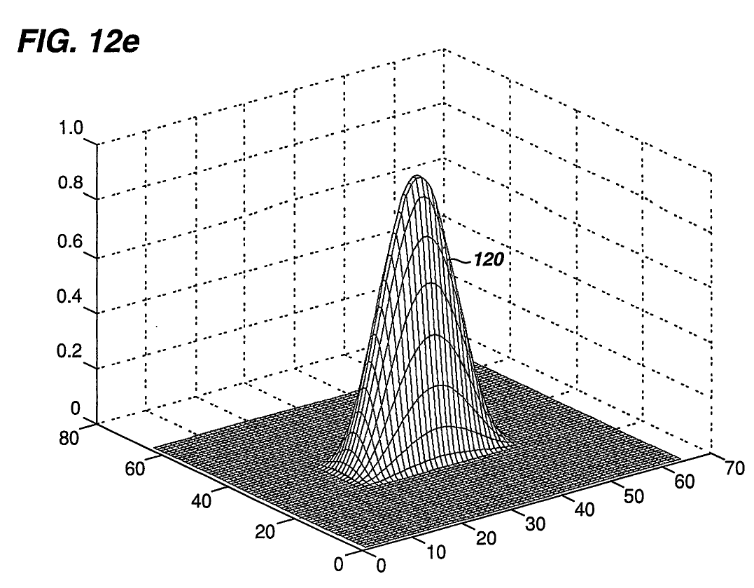

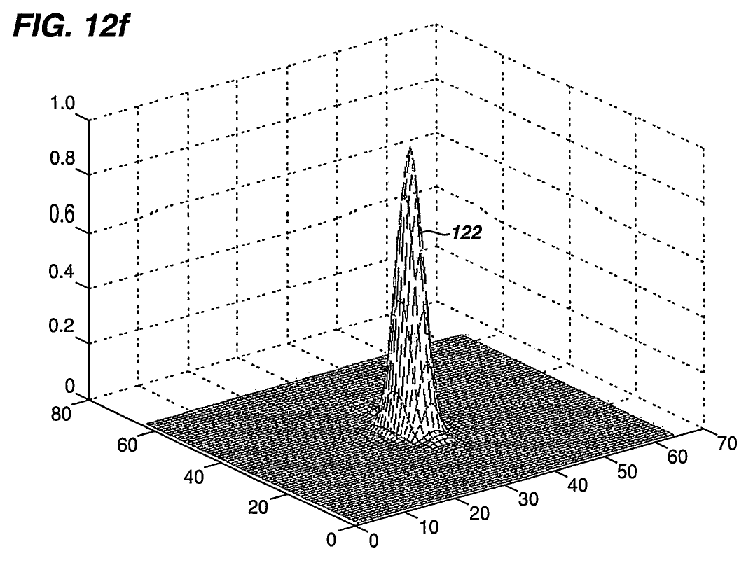

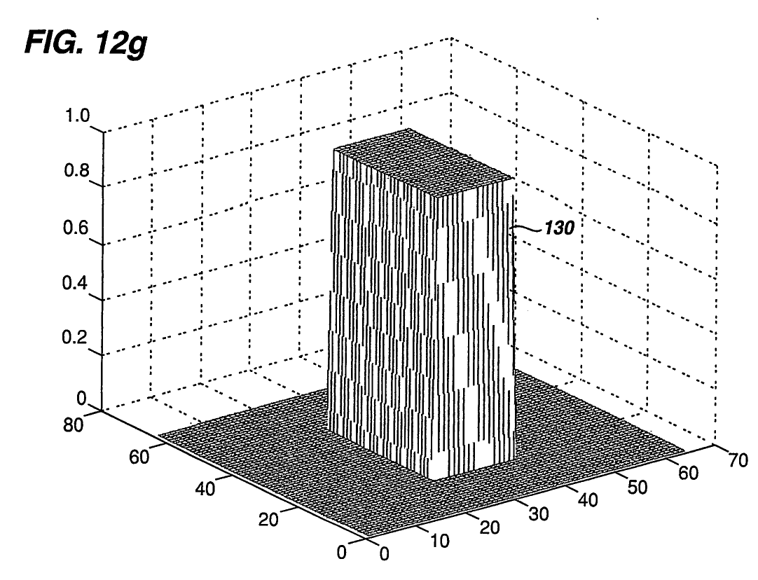

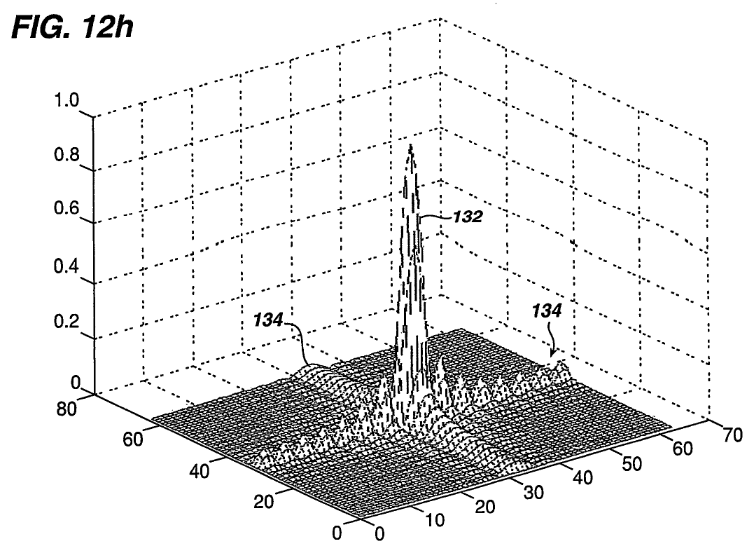

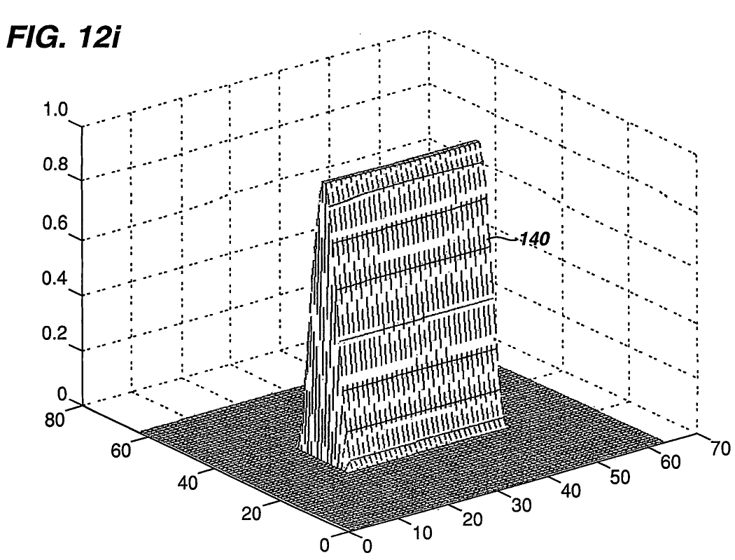

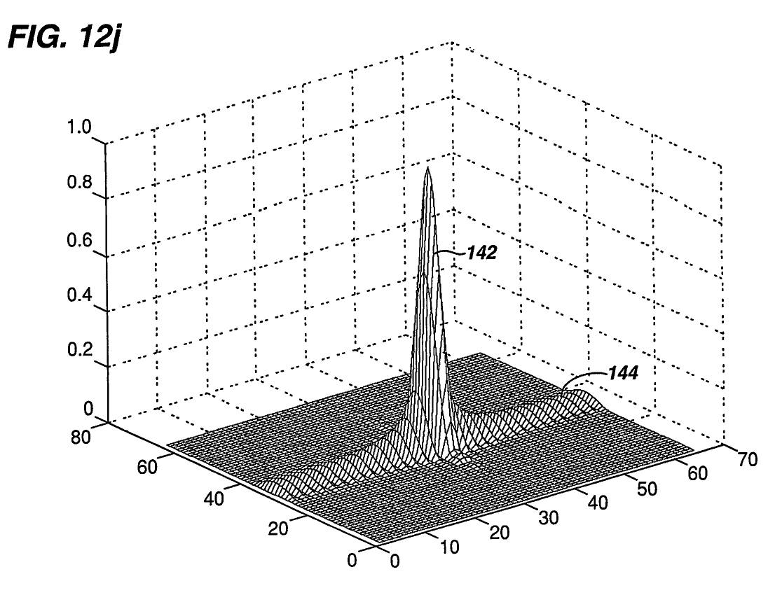

FIGS. 12a-12j illustrate the variation in point spread functions at the focus of a variety of beams with different combinations of aperture and apodization functions.

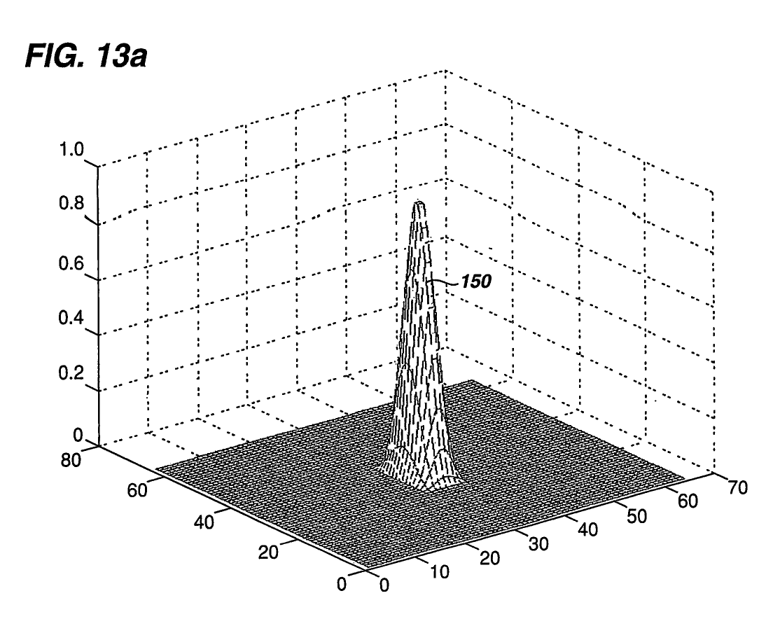

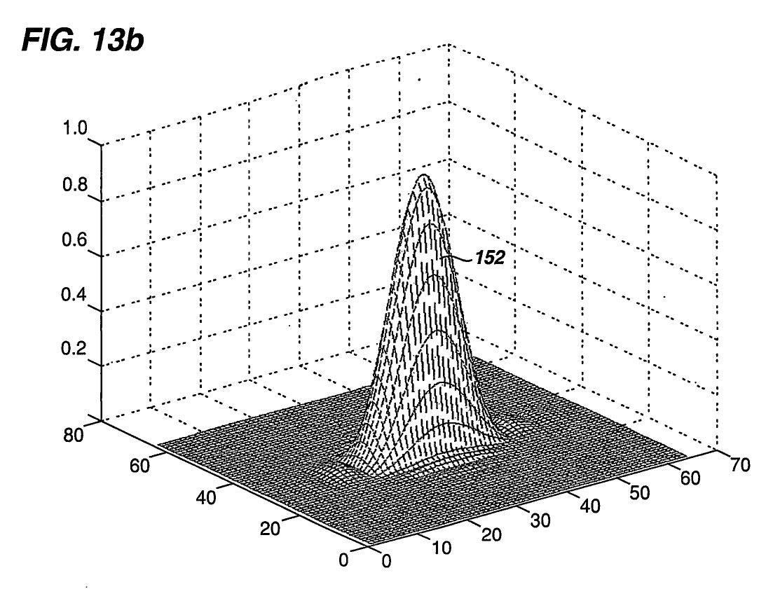

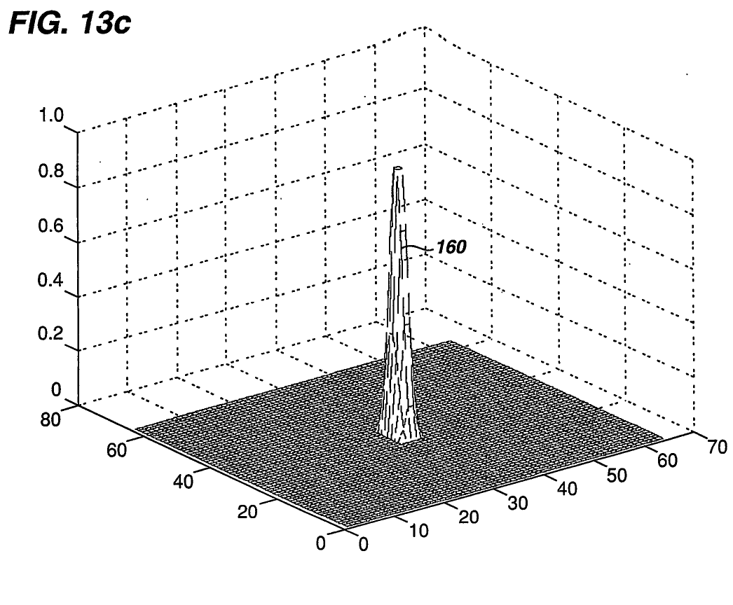

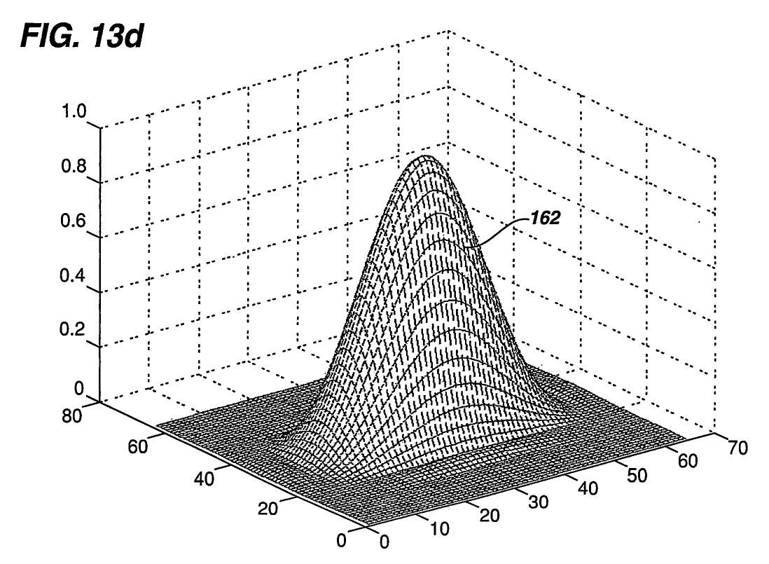

FIGS. 13a and 13b illustrate the exemplary lobe pattern of a relatively narrow ultrasound aperture in two dimensions with a point spread function which is controlled in accordance with the principles of the present invention.

FIGS. 13c and 13d illustrates the exemplary lobe pattern of a relatively broad ultrasound aperture in two dimensions with a point spread function which is controlled in accordance with the principles of the present invention.

Referring first to FIG. 1 an idealized ultrasound beam intensity profile 50 is shown. The intensity profile 50 is idealized because it is shown as a square function with the intensity (amplitude) at a constant maximum intensity and dropping to zero intensity on either side of the beam. The abscissa of the beam plot shows that in this example the beam extends a half millimeter of distance in azimuth (cross-range distance) (25.5 mm to 26.0 mm in this example) in the region of the focus of the imaging field.

To adequately spatially sample the imaging field, multiple beams must be transmitted which are spaced so as to meet the Nyquist criterion. FIG. 2 provides an illustration of a second beam which is transmitted in addition to the beam of FIG. 1 to adequately spatially sample the imaging field. The second beam has an ultrasound beam intensity profile 52 indicated by the dashed lines. The second beam intensity profile is seen to extend from 25.75 mm to 26.25 mm in this example. Since the second beam profile overlaps that of the first beam by 50%, the imaging field is being spatially sampled so as to meet the Nyquist criterion at this point, which calls for sampling at twice the frequency of the spatial information. A succession of such beams across the full angular distance of the imaging field will adequately sample the entire imaging field.

FIG. 3 shows the beam intensity profiles 50 and 54 of two beams where the beams are more widely separated. The beam intensity profiles are of the same dimensions as in the preceding examples, each extending 0.5 mm in azimuth. However, in this example the center-to-center spacing of the beams is 1 mm in distance rather than the 0.25 mm spacing of the preceding example. The wide separation of the two beams fails to satisfy the Nyquist criterion for spatial sampling, and such a beam sampling pattern can give rise to the scintillating or shimmering artifacts characteristic of spatial undersampling.

In accordance with the principles of the present invention, when the scanning beams are more widely separated, the spatial point spread functions of the beams are adjusted to account for the greater center-to-center spacing (reduced output line density) of the beams. As used herein, the point spread function refers to the two-way spatial response of a pulse-echo sequence, that is, the beam patterns of a transmit beam and its received beam or beams, use for spatial sampling. The point spread function is determined by the size of the transducer aperture employed and the apodization (weighting or intensity) function used at the aperture. The drawings herein which illustrate point spread functions generally show a one-way (transmit) relationship between the aperture and the point spread function at the beam focus. Beam focusing may be layered on top of the aperture control used to define the point spread function, which is generally done by a mechanical lens or electronic delays. FIG. 4 shows two beam intensity profiles 56 and 58 for two beams with a center-to-center spacing of 1 mm, the same as the beams of FIG. 3, but with an aperture function that produces a broader beam intensity profile (2 mm in this example). It can be seen that the two beam intensity profiles 56 and 58 overlap by 50% as in FIG. 2, resulting in satisfaction of the Nyquist criterion for spatial sampling of the imaging area with the more widely spaced beams.

The beam intensity profile of an ultrasound beam at the focal plane which is transmitted by an array transducer is not square as in the preceding drawings, but is more sinusoidal in shape, and due to the finite size of the aperture, will generally have a main lobe surrounded by side lobes as shown by the beam intensity profile 60 of FIG. 5. Whereas the extent of the beam intensity profiles of the preceding figures is clearly delineated by the instantaneous drop to zero at the sides of the square profile, an actual beam profile such as the profile 60, which rolls off gradually from its center peak, has a spatial extent determined by the criteria of the system designer. One common intensity level which is used for the effective extent of a beam intensity profile is the point at which the intensity has rolled off by 3 dB from the intensity peak, indicated by points 62 and 64 on either side of the main lobe in FIG. 5. With the 3 dB points used in this example, the effective beam dimension for spatial sampling are seen to extend over the distance from D1 to D2. For adequate Nyquist spatial sampling, the 3 dB point of the adjacent, similarly dimensioned beam 66 should fall between the 3 dB points 62 and 64 of the beam 60, as shown in FIG. 6. However, if the beams are more widely separated, that is, the width of the region being scanned increases or the beam density decreases, the point spread functions of the beams are changed so that the 3 dB points 72, 78, 74 of the beams 70 and 76 sufficiently over to satisfy the Nyquist criterion for spatial sampling as shown in FIG. 7.

A point spread function providing a broader main lobe transmit beam will insonify a broader region around the center of the beam profile. This enables the reception of a greater number of receive multilines in response to each transmit beam. As the transmit beam is broadened, the product of each multiline profile and the transmit beam profile provides an improved point spread function for each transmit-receive combination. The point spread function in this case is dominated by the narrower beam profile of each receive multiline. See U.S. Pat. No. 6,494,838 for a description of a system which increases the volumetric line density through multiline reception and scanline interpolation.

Instead of fully satisfying the Nyquist criterion for spatial sampling, it may be decided for certain applications to maintain a spatial sampling beam dispersion which falls short of the Nyquist criterion but nevertheless produces images which are satisfactory for the given procedure. For example, an obstetrician may be imaging a fetus to measure the bones of the fetus for gestational age calculation. In such an exam tissue texture may not be important but a higher frame rate may present images of a fetus moving in the womb which may be satisfactorily measured. The obstetrician will generally be satisfied if the tissue of the anatomical feature is in the correct location, in which case a lower spatial frequency will suffice. FIG. 8 illustrates two adjacent beam profiles 80, 82 which overlap at their adjacent 3 dB points 84 (position D₂ on the distance axis). While some spatial sampling artifacts may develop from this beam spread, they may not be at a level which significantly impedes the ability to make fetal bone measurements. If the volume being imaged is increased, the aperture of the transmit beams may be adjusted to broaden the beam profiles and hence the extent of spatial information being interrogated. FIG. 9 illustrates the relationship between the spatial sampling frequency and artifacts developing due to spatial undersampling graphically. The area or volume being imaged may be sampled at a spatial sampling frequency fₛ which is twice a spatial cutoff frequency f_{c} The anatomical information which is being sampled has a band of spatial frequencies 86 which rolls off to an upper frequency fₕ. Thus, spatial frequencies above f_{c} will alias back to a lower frequency f_{c}-fₕ, as indicated by the dashed line 88. In a particular application such aliasing may be acceptable; in others, it may not and spatial sampling fₛ should be done at a higher spatial frequency if textures such as the speckle pattern are desired for the diagnosis.

In an efficient data acquisition design, the sampling bandwidth or spatial resolution is matched to the achievable transducer resolution (which may be characterized by the aperture size and the acoustic wavelength) and the desired output bandwidth or volume imaging rate. Different combinations of transducer geometry, output line density and volume imaging rates lead the efficient design to use variable acquisition resolution. In an ultrasound system with a programmable beamformer, the spatial point spread function can be adjusted to best match the spatial resolution to the desired output line density, which will determine the frame rate of the two or three dimensional image. In a 3D scanning application where a maximum volume image rate is desired, the point spread function can be altered by adjustment of the apodization of the transmit aperture or receive aperture or both to match the sampling resolution to the line density. A simple example of how this adjustment can be made is illustrated with reference to FIG. 10. Suppose that the clinician wants to perform 3D imaging of a fetal heart. Further suppose that the 3D transducer probe has an array transducer that is capable of scanning a pyramidal volume 90 as shown in FIG. 10. The array transducer is located at or just above the apex 92 of the volume 90. Further suppose that the clinician finds that she can capture the entire fetal heart in a volume which measures 30° in the azimuth direction and 30° in the elevation direction and which extends to a depth of 7 cm. as shown in the drawing. The round-trip time required for sound to reach the 7 cm depth and return is assumed to be 100 μsec. in this example. This means that the acquisition time for one scanline is 100 μsec. Further assume that the clinician desires a frame rate of 30 volumes per second. From the desired frame rate of 30 vol/sec and the line time of 100 μsec/line, it is seen that 333 lines can be used to scan the volume 90 in the time allotted to meet the volume frame rate requirement. These lines are to be distributed over the volume 90. Although different line densities can be used in the azimuth and elevation directions, in this example it will be assumed that a uniform line density in both directions is to be used. The allotted number of lines can be distributed with eighteen lines in the azimuth direction and eighteen lines in the elevation direction as indicated by the small delineations along the base of the volume 90. For a volumetric sector measuring 30° by 30°, this means that the lines are on approximately a 1.6° center-to-center spacing. To meet the Nyquist criterion with a 50% overlap, a point spread function of 1.6° should be used to satisfy the Nyquist criterion in the elevation and azimuth directions. In the diagonal direction the volume will be slightly spatially undersampled, which may be overcome, if desired, by slightly widening the beam profile or increasing the line density. The ability to shape the point spread function in three dimensions with a two dimensional array transducer further enables the formation of advantageous shapes of the point spread function. For instance, the point spread function can be shaped to yield a hexagonal approximation for more efficient beam packing in a volume. See, for example, U.S. Pat. Nos. 6,384,516, 6,497,663, and application Ser. No. 09/908,294, which describe the fabrication and use of hexagonal array transducers and beam scanning.

Thus it is seen that a method to design the scanning criteria for a volumetric region starts by determining the desired output volume size (30° by 30° by 7 cm in the above example) and the desired volume acquisition rate (30 volumes/sec in the example). A line density is calculated that can be supported by the desired volume size and volume acquisition rate (333 lines/vol. in the example). The line density may be asymmetrical or symmetrical in all directions. The point spread function is then calculated that is required to sample the line density in both azimuth and azimuth (1.6° in the example). An apodization function is then chosen that provides the calculated point spread function in azimuth and elevation, for the transmit and preferably both the transmit and receive beams. An ultrasound system for carrying out this method in accordance with the principles of the present invention is shown in FIG. 11. An ultrasonic probe 10 capable of three dimensional imaging includes a two dimensional array transducer 12 which transmits beams over a three dimensional volume and receives single or multiple receive beams in response to each transmit beam. Suitable two dimensional arrays are described in U.S. patent application Ser. No. 09/663,357 and in U.S. Pat. No. 6,468,216. The transmit beam characteristics of the array are controlled by a beam transmitter 16, which causes the apodized aperture elements of the array to emit a focused beam of the desired breadth in a desired direction through a volumetric region of the body. Transmit pulses are coupled from the beam transmitter 16 to the elements of the array by means of a transmit/receive switch 14. The echo signals received by the array elements in response to a transmit beam are coupled to a beamformer 18, where the echo signals received by the elements of the array transducer are processed to form single or multiple receive beams in response to a transmit beam. A suitable beamformer for this purpose is described in U.S. patent application Ser. No. 09/746,165. Rather than housing all of the beamformer circuitry in the system beamformer 18, the beamformer circuitry may be distributed between the probe 10 and the system as described in U.S. Pat. No. 6,468,216.

The receive beams formed by the beamformer 18 are coupled to a signal processor which performs functions such as filtering and quadrature demodulation. The processed receive beams are coupled to a Doppler processor 30 and/or a B mode processor 24. The Doppler processor 30 processes the echo information into Doppler power or velocity information. The three dimensional Doppler information is stored in a 3D data memory 32, from which it can be displayed in various formats such as a 3D power Doppler display as described in U.S. Pat. No. Re. 36,564. For B mode imaging the receive beams are envelope detected and the signals logarithmically compressed to a suitable dynamic range by the B mode processor 34 and then stored in the 3D data memory 32. The 3D data memory may comprise any memory device or group of memory devices which has three address parameters. The three dimensional image data stored in the 3D data memory 32 may be processed for display in several ways. One way is to produce multiple 2D planes of the volume. This is described in U.S. Pat. No. 6,443,896. Such planar images of a volumetric region are produced by a multi-planar reformatter 34. The three dimensional image data may also be rendered to form a 3D display by a volume renderer 36. The resulting images, which may be B mode, Doppler or both as described in U.S. Pat. No. 5,720,291, are coupled to an image processor 38, from which they are displayed on an image display 40.

In accordance with the principles of the present invention the ultrasound system of FIG. 11 includes a beamformer controller 22 which controls both the beam transmitter 16 and the receive beamformer 18. The beamformer controller 22 is responsive to a user interface 20 by which a clinician may set imaging parameters for the beamformer controller. The clinician may input values for the azimuth and elevation widths of a volumetric scan region, the depth of the scan region, and a required frame rate, for instance. Ultrasound systems such as those available from Philips Ultrasound Inc. can choose these initial parameter settings automatically in response to the selection of an exam type by the clinician, a feature known as “Tissue Specific Imaging.” From these parameters the beamformer controller can calculate the number of lines which can be used to scan the volumetric region and the line density as discussed above, and the point spread function needed for that line density. Since the focal plane point spread function is the Fourier transform of the aperture function, the beamformer controller 22 can perform an inverse Fourier transform of the point spread function to calculate the needed array aperture. Alternately, the parameters for the desired point spread function can be precalculated and stored on the system for implementation together with the programmed focus parameters. It may also be sufficient to determine the point spread function “on the fly” by choosing an appropriate aperture, as the point spread function is approximately inversely proportional to the aperture function. As the signals to or from the transducer elements of the aperture are shaded (differently weighted, or apodized), the point spread function will broaden to accommodate a greater line spacing (lesser line density). Stated another way, the beam width is inversely proportional to the aperture width. By varying the number of transducer elements and their locations of the active aperture for transmit and/or receive, and the weightings of the signals to or from those elements (which also affects side lobe characteristics), the width of the main lobe of the acoustic beam is tailored for the desired point spread function. See Optics, Second Edition by Eugene Hecht (Addison-Wesley Pub. Co.) at Ch. 11, and Introduction To Fourier Optics by J. W. Goodman (McGraw-Hill Book Co.) at Ch. 4, in which these principles are illustrated in the field of optics.

FIGS. 12a-12j illustrate the variation in point spread functions with different aperture and apodization combinations for volumetric imaging in accordance with the principles of the present invention. In each of these drawings the numbers at the base grid refer to size measures in the elevation and azimuth directions. For an array of transducer elements that are uniformly sized and spaced in both elevation and azimuth, the base grid of these drawings would correspond to the elements of a 64 element by 64 element transducer array. The height of the beam pattern above each point on the grid (element) corresponds to the relative apodization function at that particular point (element of the array.) Thus, the shape of grid area beneath each beam pattern indicates the elements used for the active aperture and the shape of the beam pattern above those elements shows the apodization function used to produce the point spread function at the focus. In FIG. 12a the active aperture comprises a symmetrical central area of sixteen elements in azimuth and sixteen elements in elevation. A Hanning window is used for apodization in both the elevation and azimuth directions as shown by the shape 100. This aperture function will produce a point spread function or beam pattern 102 at the focus as shown in FIG. 12b with the greatest intensity (greatest weighting) in the center and declining smoothly and uniformly in both the elevation and azimuth directions from the center. The Hanning window apodization results in relatively low side lobe levels.

FIG. 12c illustrates an aperture function 110 produced by an asymmetrical 1:2 aperture of sixteen elements in azimuth and thirty-two elements in elevation. A Hanning window is used to smoothly apodize the aperture in each dimension from a common central point in the center of the transducer. This aperture function produces the point spread function or beam pattern 112 as shown in FIG. 12d. The aperture function which is broader in the elevation dimension is seen to produce a point spread function 112 which is narrower in the elevation dimension at the focus. A point spread functions such as that shown in FIG. 12d might be used when a greater spatial resolution or different number of multilines is desired in one dimension as opposed to the other.

FIG. 12e shows a reversal of the aperture function of FIG. 12c. In this case the aperture function 120 has a greater breadth in the azimuth dimension, producing a beam pattern or point spread function 122 which is narrower in the azimuth dimension, as shown in FIG. 12f This point spread function might be used when greater lateral resolution in the azimuth dimension or higher multiline order in the elevation dimension are desired.

FIG. 12g illustrates the aperture function 130 of a 1:2 aperture with unvarying (rectangular) apodization. The lack of a smooth apodization function produces a beam pattern or point spread function at the focus which exhibits a main lobe 132 and side lobes 134 in both the elevation and azimuth dimensions. If a smoothly varying Hanning window were used for the apodization function in the elevation dimension as shown by the aperture function 140 in FIG. 12i, the resultant point spread function 142 would have the significant side lobes 144 in the azimuth dimension but not the elevation dimension as shown in FIG. 12j.

FIGS. 13a-13d illustrate how the aperture function can be changed by the setting of the aperture and apodization functions by the beamformer controller to produce a broader or narrower point spread function that provides the desired spatial sampling frequency. FIG. 13a shows an asymmetric three dimensional aperture function 150 with an active aperture of eight elements by sixteen elements and Hanning window apodization in both elevation and azimuth. This aperture function produces a point spread function 152 at the focus as shown in FIG. 13b. The point spread function 152 is relatively narrow in the elevation dimension and broader in the azimuth dimension with relatively low side lobe levels. If the volume which is scanned with beams of this nature is to be scanned at a higher frame rate, an aperture function 160 as shown in FIG. 13c could be used. As FIG. 13c shows, the new aperture function only occupies an aperture of five elements by eight elements and is apodized with a Hanning window. This aperture function will produce a much broader point spread function 162 at the focus as shown by FIG. 13d. It can be seen that fewer beams of the beam pattern of FIG. 13d will be needed to scan a volume of a given size than beams of the beam pattern of FIG. 13b, thus enabling the volume to be scanned at a higher volume display rate.

An embodiment of the present invention can, if desired, advantageously provide increased scan depths as the point spread function is varied. The acoustic output of medical ultrasound transducers is regulated in most countries by maximum allowable levels of peak acoustic pressure and of average or long-term thermal energy. In the United States these parameters are controlled by limiting the Mechanical Index and I_{SPTA} of the acoustic transmissions. FIG. 13b illustrates the beam profile of a relatively narrow point spread function where most of the energy of the transmitted beam is concentrated in a relatively narrow central lobe 152 which extends over a relatively narrow central area of the array and hence is relatively concentrated in the body. To avoid exceeding peak acoustic pressure limits the energy in the relatively tightly contained area of the central lobe 152 must be limited to relatively low levels and the narrow lateral extent of the beam profile limits the overall energy provided by the beam. FIG. 13d, on the other hand, illustrates the beam profile of a relatively broader point spread function which may be used when the clinician calls for a higher volumetric frame rate or a wider volumetric region. In such cases broader point spread functions for a decreased beam density meeting the Nyquist or Nyquist-related criterion are employed. For this beam the energy from the array transducer is distributed over a greater area in the body, the area of the broader beam pattern 162. More energy can be transmitted by fewer transducers since the point spread function exhibits this broader lobe. Consequently the transmitted beam contains more energy and can penetrate to greater depths in the body, returning clinically useful echo information from greater depths without violating acoustic output limits. Accordingly, by varying the total acoustic output power in concert with changes in the point spread function, the changes in the point spread function can advantageously be used to increase acoustic penetration and the clinically useful depth of the image.

As the point spread function is relaxed (broadened), the effective focal range of the beam extends over a wider range of depths. The extended depth of focus means that an increased depth of field can be imaged and remain in focus. An increased depth of field can reduce the need for multiple focal zones, thereby increasing the volumetric frame rate. A reduction in the need for multiple focal zones is very significant in three dimensional imaging because the volume frame rate reduction caused by multiple transmit focal zones can be severe.

Other considerations may also affect the design of the apodization function. For instance, a phased array which is angularly steered will perform differently at the sides of the array where the steeply steered beams cause transducer acceptance angle effects. When the angular sampling density is to be maintained constant throughout the volume, the apodization function may vary with beam angle to compensate for transducer acceptance angle effects that otherwise would lead to a variable point spread function in different parts of the image region.

Other variations will readily occur to those skilled in the art. For instance, the ability to shape the point spread function enables the beam density and beamwidth to be varied throughout the image field. A higher beam density could be employed in the center of a volume, with a relaxed point spread function and lower beam density used at the lateral extremes of the volume. The beam density can be varied continuously from the center to the sides of the volume being scanned.

An embodiment of the present invention can be used as desired to improve the information content of the echo information and the information movement efficiency by not acquiring more resolution than can be utilized. It can also provide a more optimal sampling function by using the aperture function to limit the spatial (azimuth and elevation) bandwidth for three dimensional imaging.

1. An ultrasonic diagnostic imaging system for three dimensional scanning comprising:
an array transducer having a plurality of transducer elements;
a beamformer coupled to the array transducer which causes the transducer to scan a volumetric region with a plurality of transmit beams and to receive echo information in response to transmit beams, the beamformer controlling the point spread functions of beams transmitted and/or received by the beamformer;
an image processor coupled to the beamformer which produces image signals in response to the echo information; and
a display coupled to the image processors,
wherein beams produced by the beamformer exhibit a first point spread function when the volumetric region is scanned with a first line density and a second point spread function when the volumetric region is scanned with a second line density.

2. The ultrasonic diagnostic imaging system of claim 1, wherein the point spread function comprises the two-way spatial response at a focal region of pulse-echo spatial sampling of the volumetric region.

3. The ultrasonic diagnostic imaging system of claim 1, wherein the transmit beams exhibit a relatively narrower beam profile at the focus when scanning the volumetric region with a first line density, and the transmit beams exhibit a relatively broader beam profile at the focus when scanning the volumetric region with a second line density which is less than the first line density.

4. The ultrasonic diagnostic imaging system of claim 3, wherein adjacent beams overlap at substantially the same intensity levels when scanning the volumetric region with the first and second line densities.

5. The ultrasonic diagnostic imaging system of claim 4, wherein the transmit beams satisfy the Nyquist criterion for spatial sampling of the volumetric region to substantially the same degree.

6. The ultrasonic diagnostic imaging system of claim 1, wherein the point spread functions satisfy the Nyquist criterion for spatial sampling of the volumetric region to substantially the same degree.

7. The ultrasonic diagnostic imaging system of claim 1, wherein the beam point spread function exhibit both an azimuth dimension and an elevation dimension;
wherein point spread function is symmetrical in both the azimuth and elevation dimensions.

8. The ultrasonic diagnostic imaging system of claim 1, wherein the beam point spread function exhibit both an azimuth dimension and an elevation dimension;
wherein point spread function is asymmetrical in the azimuth and elevation dimensions.

9. An ultrasonic diagnostic imaging system for three dimensional scanning comprising:
an array transducer having a plurality of transducer elements;
a beamformer coupled to the array transducer which causes the transducer to scan a volumetric region with a plurality of transmit beams and to receive echo information in response to transmit beams, the beamformer controlling the point spread functions of beams transmitted and/or received by the beamformer by control of the aperture function of the array transducer;
an image processor coupled to the beamformer which produces image signals in response to the echo information; and
a display coupled to the image processors,
wherein the beamforner utilizes a first aperture function when the volumetric region is scanned with a first line density and a second aperture function when the volumetric region is scanned with a second line density.

10. The ultrasonic diagnostic imaging system of claim 9, wherein the aperture function comprises the combination of the elements used in an active aperture of the array transducer and the apodization function of the elements of the active aperture.

11. The ultrasonic diagnostic imaging system of claim 10, wherein the apodization function is controlled to match the point spread function to the line spacing when scanning the volumetric region with the first and second line densities.

12. The ultrasonic diagnostic imaging system of claim 11, wherein the first line density is greater than the second line density; and
wherein the apodization function is controlled to scan an increased depth-of-field when scanning the volumetric region with the second line density.

13. The ultrasonic diagnostic imaging system of claim 10, wherein the apodization function comprises the relative weighting of signals of the respective elements of the active aperture during a transmission or reception event.

14. The ultrasonic diagnostic imaging system of claim 9, wherein the first and second aperture functions satisfy the Nyquist criterion for spatial sampling of the volumetric region to substantially the same degree.

15. The ultrasonic diagnostic imaging system of claim 14, wherein the first and second aperture functions both substantially exactly satisfy the Nyquist criterion for spatial sampling of the volumetric region.

16. The ultrasonic diagnostic imaging system of claim 10, wherein the scanning beams exhibit a substantially constant angular sampling density; and
wherein the apodization function is varied as a function of beam angle to compensate for transducer acceptance angle effects.

17. In an ultrasonic diagnostic imaging system for volumetric scanning and which includes a user interface, a method for determining the point spread function used to spatially sample a volumetric region comprising:
determining the desired size of the volumetric region to be scanned;
determining the desired volume acquisition rate;
calculating the line density for scanning the volumetric region of the desired size at the desired volume acquisition rate; and
calculating the point spread function which will spatially sample the volumetric region at the line density.

18. The method of claim 17, wherein calculating the point spread function further comprises calculating the point spread function which satisfies the Nyquist criterion for spatial sampling of the volumetric region to a desired degree.

19. The method of claim 17, further comprising:
determining an aperture function that provides the calculated point spread function.

20. The method of claim 19, wherein determining an aperture function comprises determining an apodization function for an active aperture that provides the calculated point spread function.

21. The method of claim 17, wherein determining the desired volume acquisition rate comprises determining the volume frame rate of display.

22. The method of claim 17, wherein calculating the point spread function comprises determining an aperture function which is approximately inversely proportional to a desired point spread function.
